(19) United States
(12) Patent Application Publication
(10) Pub. No.: US 2023/0402216 A1
(43) Pub. Date: Dec. 14, 2023

(54) MULTILAYER COIL COMPONENT

(71) Applicant: TDK CORPORATION, Tokyo (JP)

(72) Inventors: Yuto SHIGA, Tokyo (JP); So KOBAYASHI, Tokyo (JP); Youichi KAZUTA, Tokyo (JP); Yuichi TAKUBO, Tokyo (JP); Xuran GUO, Tokyo (JP)

(73) Assignee: TDK CORPORATION, Tokyo (JP)

(21) Appl. No.: 18/317,997

(22) Filed: May 16, 2023

(30) Foreign Application Priority Data
Jun. 14, 2022 (JP) 2022-095838

(51) Int. Cl. H01F 17/00; H01F 27/29

(52) U.S. Cl. CPC H01F 17/0013; H01F 27/292; H01F 2027/2809

(57) ABSTRACT

A coil includes a plurality of coil conductors. The coil includes a plurality of connection portions each at which adjacent coil conductors of the plurality of coil conductors are electrically connected to each other and the adjacent coil conductors overlap each other. The plurality of connection portions include a first connection portion and a second connection portion that is farther from an electrode portion on a main surface than the first connection portion. A second area where the adjacent coil conductors overlap each other in the second connection portion is larger than a first area where the adjacent coil conductors overlap each other in the first connection portion.

### CROSS-REFERENCE TO RELATED APPLICATIONS

This application is based upon and claims the benefit of priority from Japanese Patent Application No. 2022-095838, filed on Jun. 14, 2022, the entire contents of which are incorporated herein by reference.

### BACKGROUND

### Field

The present disclosure relates to a multilayer coil component.

### Description of the Related Art

Known multilayer coil components include an element body, a coil, and a pair of external electrodes (see, for example, Japanese Unexamined Patent Publication No. 2018-41864). The element body includes a main surface and a pair of side surfaces. The coil includes a plurality of coil conductors. The external electrode includes a main-surface electrode portion on the main surface. The plurality of coil conductors are disposed in a direction in which the pair of side surfaces oppose each other, and are electrically connected to each other. The coil includes a plurality of connection portions. At each of the plurality of connection portions, adjacent coil conductors of the plurality of coil conductors are electrically connected to each other, and the adjacent coil conductors overlap each other when viewed from the direction in which the pair of side surfaces oppose each other.

### SUMMARY

One aspect of the present disclosure provides a multilayer coil component capable of reducing direct current resistance and preventing an increase in stray capacitance.

A multilayer coil component according to one aspect of the present disclosure includes an element body, a coil in the element body, and a pair of external electrodes electrically connected to the coil. The element body includes a main surface and a pair of side surfaces adjacent the main surface and opposing each other. The coil includes a plurality of coil conductors. The plurality of coil conductors are disposed in a direction in which the pair of side surfaces oppose each other and are electrically connected to each other. Each of the pair of external electrodes includes a main-surface electrode portion on the main surface. The coil includes a plurality of connection portions. At each of the plurality of connection portions, adjacent coil conductors of the plurality of coil conductors are electrically connected to each other, and the adjacent coil conductors overlap each other in the direction in which the pair of side surfaces oppose each other. The plurality of connection portions include a first connection portion and a second connection portion that is more distant from the main-surface electrode portion than the first connection portion. A second area where the adjacent coil conductors overlap each other in the second connection portion is larger than a first area where the adjacent coil conductors overlap each other in the first connection portion.

In the one aspect described above, the second area is larger than the first area. The one aspect described above can increase a contact area between the adjacent coil conductors at the second connection portion. Therefore, the one aspect described above can reduce direct current resistance.

An increase in the second area may increase an area where the second connection portion and the main-surface electrode portion oppose each other. An increase in the area where the second connection portion and the main-surface electrode portion oppose each other may increase stray capacitance between the plurality of connection portions and the main-surface electrode portion. In the one aspect described above, the second connection portion is more distant from the main-surface electrode portion than the first connection portion. Therefore, even when the second area increases, the one aspect described above can prevent an increase in the stray capacitance.

### BRIEF DESCRIPTION OF THE DRAWINGS

FIG. 1 is a perspective view illustrating a multilayer coil component according to an example;

FIG. 2 is a view illustrating a plurality of connection portions included in the multilayer coil component according to the present example;

FIG. 3 is an exploded view schematically illustrating a configuration of the multilayer coil component according to the present example;

FIG. 4 is a view illustrating a plurality of connection portions included in a multilayer coil component according to a first modified example of the present example;

FIG. 5 is an exploded view schematically illustrating a configuration of the multilayer coil component according to the first modified example of the present example;

FIG. 6 is a view illustrating a plurality of connection portions included in a multilayer coil component according to a second modified example of the present example;

FIG. 7 is an exploded view schematically illustrating a configuration of the multilayer coil component according to the second modified example of the present example;

FIG. 8 is a view illustrating a plurality of connection portions included in a multilayer coil component according to a third modified example of the present example;

FIG. 9 is an exploded view schematically illustrating a configuration of the multilayer coil component according to the third modified example of the present example; and

FIG. 10 is a perspective view illustrating a multilayer coil component according to a fourth modified example of the present example.

### DETAILED DESCRIPTION

In the following description, with reference to the drawings, the same reference numbers are assigned to the same components or to similar components having the same function, and overlapping description is omitted.

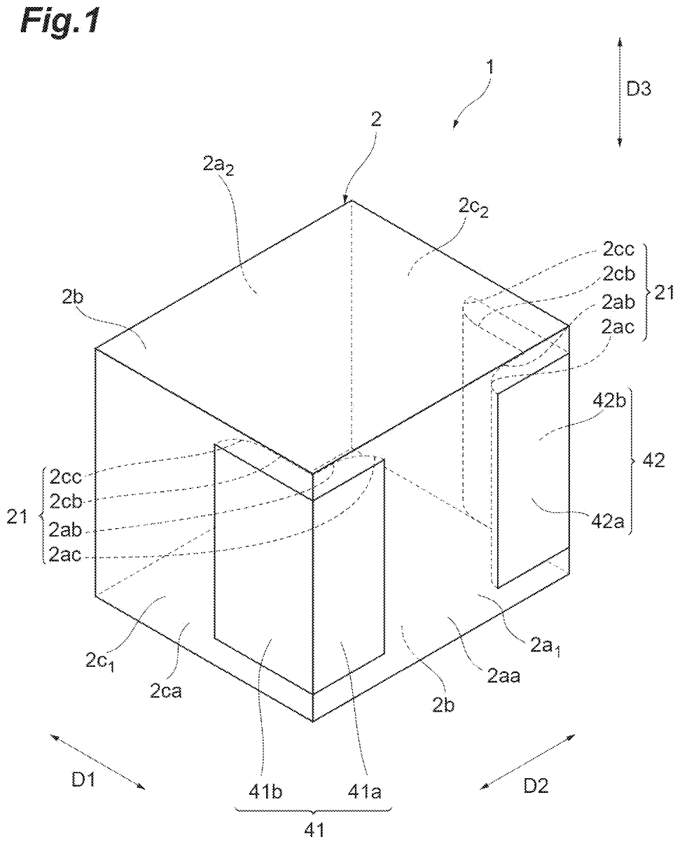

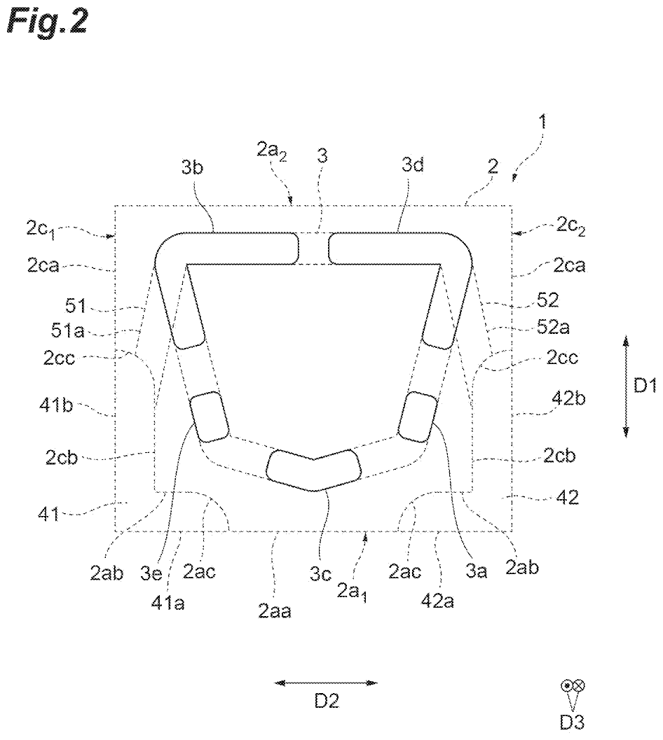

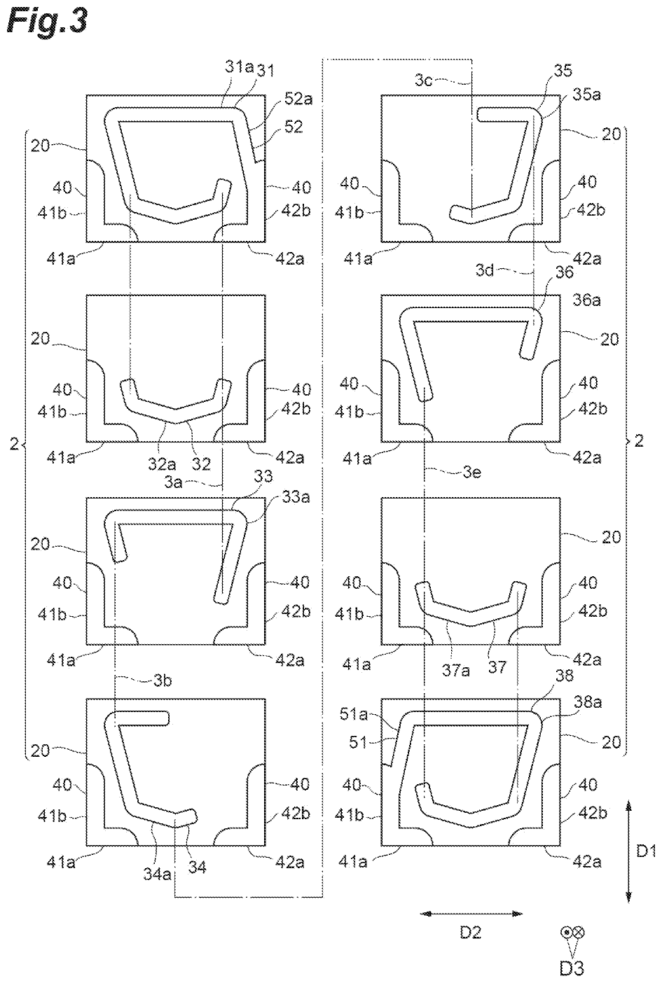

A configuration of a multilayer coil component 1 according to the present example will be described with reference to FIG. 1 to FIG. 3. FIG. 1 is a perspective view illustrating a multilayer coil component according to the present example. FIG. 2 is a view illustrating a plurality of connection portions included in the multilayer coil component according to the present example. FIG. 3 is an exploded view schematically illustrating a configuration of the multilayer coil component according to the present example. The multilayer coil component 1 is solder-mounted on an electronic device, for example.

The electronic device includes, for example, a circuit board or an electronic component.

As illustrated in FIG. 1 to FIG. 3, the multilayer coil component 1 includes an element body 2 of a rectangular parallelepiped shape, a coil 3 in the element body 2, a pair of external electrodes 41 and 42, and a pair of connection conductors 51 and 52. The rectangular parallelepiped shape includes, for example, a rectangular parallelepiped shape in which corner portions and ridge portions are chamfered or a rectangular parallelepiped shape in which corner portions and ridge portions are rounded.

The element body 2 includes a pair of main surfaces 2a₁ and 2a₂ opposing each other, a pair of side surfaces 2b opposing each other, and a pair of end surfaces 2c₁ and 2c₂ opposing each other. Each of the pair of main surfaces 2a₁ and 2a₂, the pair of side surfaces 2b, and the pair of end surfaces 2c₁ and 2c₂ has a substantially rectangular shape. The pair of main surfaces 2a₁ and 2a₂ and the pair of side surfaces 2b are adjacent to each other. The pair of end surfaces 2c₁ and 2c₂ are adjacent to the pair of main surfaces 2a₁ and 2a₂ and the pair of side surfaces 2b. In the multilayer coil component 1 mounted on the electronic device, for example, the main surface 2a₁ opposes the electronic device. The main surface 2a₁ is arranged to constitute a mounting surface. For example, when the main surface 2a₁ includes one main surface, the main surface 2a₂ includes another main surface.

The pair of main surfaces 2a₁ and 2a₂ oppose each other in a direction D1. The direction D1 is orthogonal to each of the pair of main surfaces 2a₁ and 2a₂. The pair of side surfaces 2b oppose each other in a direction D3. The direction D1 is orthogonal to the direction D3. The direction D3 is orthogonal to each of the pair of side surfaces 2b. The pair of end surfaces 2c₁ and 2c₂ oppose each other in a direction D2. The direction D2 is orthogonal to each of the pair of end surfaces 2c₁ and 2c₂ and parallel to the pair of main surfaces 2a₁ and 2a₂ and the pair of side surfaces 2b. The direction D2 is orthogonal to the direction D1 and the direction D3.

The element body 2 is formed with a pair of depressions 21. The pair of depressions 21 are located at both ends of the main surface 2a₁ in the direction D2. One of the pair of depressions 21 is also located at an end of the end surface 2c₁ closer to the main surface 2a₁. Another one of the pair of depressions 21 is also located at an end of the end surface 2c₂ closer to the main surface 2a₁.

The main surface 2a₁ includes a region 2aa and a pair of regions 2ab. Each region 2ab is closer to the main surface 2a₂ than the region 2aa in the direction D1. The pair of regions 2ab are located at both ends of the main surface 2a₁ in the direction D2, for example. A step region 2ac is formed between the region 2aa and the region 2ab. The region 2aa opposes the electronic device on which the multilayer coil component 1 is solder-mounted. For example, if the region 2aa includes a first region, the region 2ab may include a second region. A region defining the depression 21 includes the region 2ab and the step region 2ac.

Each of the pair of end surfaces 2c₁ and 2c₂ includes a region 2ca and a region 2cb. In the end surface 2c₁, the region 2cb is closer to the end surface 2c₂ than the region 2ca in the direction D2. In the end surface 2c₂, the region 2cb is closer to the end surface 2c₁ than the region 2ca in the direction D2. The region 2cb included in the end surface 2c₁ is located at an end of the end surface 2c₁ closer to the main surface 2a₁. The region 2cb included in the end surface 2c₂ is located at an end of the end surface 2c₂ closer to the main surface 2a₁. A step region 2cc is formed between the region 2ca and the region 2cb. The region defining the depression 21 includes the region 2cb and the step region 2cc. The region 2ab and the region 2cb are continuous with each other at a ridge portion of the element body 2. The region defining the depression 21 includes the region 2ab, the step region 2ac, the region 2cb, and the step region 2cc.

The external electrodes 41 and 42 has a substantially L-shape (or a substantially inverted L-shape) when viewed from the direction D3. The external electrode 41 includes a main-surface electrode portion 41a and an end-surface electrode portion 41b. The external electrode 42 includes a main-surface electrode portion 42a and an end-surface electrode portion 42b. The main-surface electrode portion 41a and the end-surface electrode portion 41b are continuous and integrated with each other. The main-surface electrode portion 42a and the end-surface electrode portion 42b are continuous and integrated with each other. Each of the pair of external electrodes 41 and 42 corresponds to a corresponding depression 21 of the pair of depressions 21. A plating layer may be disposed on each surface of the external electrodes 41 and 42. The plating layer is formed through, for example, electroplating or electroless plating. The plating layer includes, for example, Ni, Sn, or Au. Lengths of the end-surface electrode portions 41b and 42b in the direction D1 are larger than lengths of the main-surface electrode portions 41a and 42a in the direction D2.

The main-surface electrode portions 41a and 42a are disposed on the main surface 2a₁. The main-surface electrode portions 41a and 42a are disposed on the main surface 2a₁ along the main surface 2a₁, for example. As illustrated in FIG. 1, each of the main-surface electrode portions 41a and 42a is disposed on the step region 2ac and the region 2ab. Each surface of the main-surface electrode portions 41a and 42a is flush with a surface of the region 2aa. Each surface of the main-surface electrode portions 41a and 42a may not be flush with the surface of the region 2aa.

The end-surface electrode portion 41b is disposed on the end surface 2c₁. The end-surface electrode portion 41b is disposed on the side surface 2c₁₂ along the end surface 2c₁, for example. The end-surface electrode portion 42b is disposed on the end surface 2c₂. The end-surface electrode portion 42b is disposed on the side surface 2c₂ along the end surface 2c₂, for example. As illustrated in FIG. 1, each of the end-surface electrode portions 41b and 42b is disposed on the step region 2cc and the region 2cb. Each surface of the main-surface electrode portions 41b and 42b is flush with a surface of the region 2ca. Each surface of the main-surface electrode portions 41b and 42b may not be flush with the surface of the region 2ca.

The coil 3 is disposed in the element body 2. The coil 3 includes a plurality of coil conductors 31, 32, 33, 34, 35, 36, 37, and 38. The plurality of coil conductors 31 to 38 are disposed in the direction D3 and are electrically connected to each other. The coil conductor 32 is adjacent to the coil conductors 31 and 33 in the direction D3. The coil conductor 32 is located between the coil conductor 31 and the coil conductor 33 in the direction D3. The coil conductor 34 is adjacent to the coil conductors 33 and 35 in the direction D3. The coil conductor 34 is located between the coil conductor 33 and the coil conductor 35 in the direction D3. The coil conductor 36 is adjacent to the coil conductors 35 and 37 in the direction D3. The coil conductor 36 is located between the coil conductor 35 and the coil conductor 37 in the direction D3. The coil conductor 37 is adjacent to the coil conductor 38 in the direction D3. The coil conductor 37 is located between the coil conductor 36 and the coil conductor 38 in the direction D3. Each of the coil conductors 31 to 38 includes a part of an annular path in the coil 3. Each of the coil conductors 31 to 38 has, for example, a shape in which a part of a loop is interrupted. Each of the coil conductors 31 to 38 includes a pair of ends and has a shape substantially along the annular path from the one end to the other end. The coil 3 includes eight coil conductors 31 to 38 coupled in the direction D3. The number of turns of each of the coil conductors 31 to 38 is, for example, at least approximately “⅖”. The number of turns of the coil 3 is, for example, approximately “3.5”. The coil 3 includes a pair of ends.

As illustrated in FIG. 2, the coil 3 includes a plurality of connection portions 3a, 3b, 3c, 3d, and 3e. In each of the connection portions 3a to 3e, adjacent coil conductors of the plurality of coil conductors 32 to 37 are electrically connected to each other, and the adjacent coil conductors overlap each other when viewed from the direction D3. In the connection portion 3a, the coil conductor 32 and the coil conductor 33 are continuous with each other. In the connection portion 3b, the coil conductor 33 and the coil conductor 34 are continuous with each other. In the connection portion 3c, the coil conductor 34 and the coil conductor 35 are continuous with each other. In the connection portion 3d, the coil conductor 35 and the coil conductor 36 are continuous with each other. In the connection portion 3e, the coil conductor 36 and the coil conductor 37 are continuous with each other. In FIG. 2, elements other than the plurality of connection portions 3a, 3b, 3c, 3d, and 3e are indicated by broken lines in order to emphasize the plurality of connection portions 3a, 3b, 3c, 3d, and 3e.

Each of the plurality of coil conductors 32 to 37 includes a connection end constituting a corresponding connection portion of the plurality of connection portions 3a to 3e. The connection portion 3a includes the one end (connection end) of the coil conductor 32 and the one end (connection end) of the coil conductor 33. The connection portion 3b includes the other end (connection end) of the coil conductor 33 and the one end (connection end) of the coil conductor 34. The connection portion 3c includes the other end (connection end) of the coil conductor 34 and the one end (connection end) of the coil conductor 35. The connection portion 3d includes the other end (connection end) of the coil conductor 35 and the one end (connection end) of the coil conductor 36. The connection portion 3e includes the other end (connection end) of the coil conductor 36 and the one end (connection end) of the coil conductor 37. In the present example, the adjacent connection ends overlap with each other as a whole in a widthwise direction of the connection ends when viewed from the direction D3. The adjacent connection ends may partially overlap each other in the widthwise direction of the connection ends when viewed from the direction D3. For example, the adjacent connection ends may overlap each other by half or more of lengths of the connection ends in the widthwise direction when viewed from the direction D3.

When viewed from the direction D3, the coil 3 has a substantially pentagonal shape. For example, when viewed from the direction D3, each of the connecting portions 3a to 3e is located on a corresponding side of a plurality of sides of the substantially pentagonal shape that is the shape of the coil 3. The plurality of sides includes one long side, a pair of first short sides, and a pair of second short sides. The long side is adjacent to the main surface 2a₂ and extends along the direction D2. Each of the pair of first short sides extends from a corresponding end of both ends of the long side toward the main-surface electrode portions 41a and 42a. Each of the pair of second short sides extends from an end of a corresponding first short side of the pair of first short sides toward the main surface 2a₁. The long side is longer than each first short side. Each first short side is longer than each second short side. Each first short side is adjacent to a corresponding electrode portion of the end-surface electrode portions 41b and 42b. Each second short side is adjacent to a corresponding electrode portion of the main-surface electrode portions 41a and 42a. When viewed from the direction D3, each of the connection portions 3b and 3d extends along a part of the long side and a part of the corresponding first short side of the pair of first short sides. When viewed from the direction D3, each of the connection portions 3a and 3e extends along a part of the corresponding first short side of the pair of first short sides. When viewed from the direction D3, the connection portion 3c extends along a part of each of the pair of second short sides.

The connection portions 3b and 3d are more distant from the main-surface electrode portions 41a and 42a than the connection portions 3a, 3c, and 3e. The connection portions 3a, 3c, and 3e are closer to the main-surface electrode portions 41a and 42a than the connection portions 3b and 3d. In the direction D1, the connection portions 3b and 3d may be closer to the main surface 2a₂ than the end-surface electrode portions 41b and 42b. For example, at least one of the connection portions 3a, 3c, and 3e includes a first connection portion. For example, at least one of the connection portions 3b and 3d includes a second connection portion. Each of the connection portions 3a, 3c, and 3e may be included in a first group. Each of the connection portions 3b and 3d may be included in a second group. Areas of the connection portions 3b and 3d when viewed from the direction D3 are larger than areas of the connection portions 3a, 3c, and 3e when viewed from the direction D3. An area where the adjacent coil conductors 33 and 34 overlap each other at the connecting portion 3b is larger than an area where the adjacent coil conductors 32 and 33 overlap each other at the connection portion 3a, larger than an area where the adjacent coil conductors 34 and 35 overlap each other at the connection portion 3c, and larger than an area where the adjacent coil conductors 36 and 37 overlap each other at the connection portion 3e. An area where the adjacent coil conductors 35 and 36 overlap each other at the connection portion 3d are larger than the area where the adjacent coil conductors 32 and 33 overlap each other at the connection portion 3a, larger than the area where the adjacent coil conductors 34 and 35 overlap each other at the connection portion 3c, and larger than the area where the adjacent coil conductors 36 and 37 overlap each other in the connection portion 3e. The areas of the connection portions 3a and 3e when viewed from the direction D3 are smaller than the area of the connection portion 3c when viewed from the direction D3. The area where the adjacent coil conductors 32 and 33 overlap each other at the connection portion 3a is smaller than the area where the adjacent coil conductors 34 and 35 overlap each other at the connection portion 3c.

The area where the adjacent coil conductors 36 and 37 overlap each other at the connection portion 3e is smaller than the area where the adjacent coil conductors 34 and 35 overlap each other at the connection portion 3c. For example, when the area where the adjacent coil conductors overlap each other at each of the connection portions 3a, 3c, and 3e includes a first areas, the area where the adjacent coil conductors overlap each other at each of the connection portions 3b and 3d includes a second areas.

The connection portion 3a is adjacent to the main-surface electrode portion 42a and the end-surface electrode portion 42b. The connection portion 3e is adjacent to the main-surface electrode portion 41a and the end-surface electrode portion 41b. Each of the connection portions 3a and 3e may be included in a third group. The connection portion 3c is adjacent to the region 2aa. The connection portion 3c is adjacent to the end-surface electrode portion 41b. The connection portion 3c may be included in the third group. Each of the connection portions 3b and 3d may be included in a fourth group. A sum of the area where the adjacent coil conductors 33 and 34 overlap each other at the connection portion 3b and the area where the adjacent coil conductors 35 and 36 overlap each other at the connection portion 3d is larger than a sum of the area where the adjacent coil conductors 32 and 33 overlap each other at the connection portion 3a and the area where the adjacent coil conductors 36 and 37 overlap each other at the connection portion 3e. The sum of the area where the adjacent coil conductors 33 and 34 overlap each other at the connection portion 3b and the area where the adjacent coil conductors 35 and 36 overlap each other at the connecting portion 3d is larger than a sum of the area where the adjacent coil conductors 32 and 33 overlap each other at the connection portion 3a, the area where the adjacent coil conductors 34 and 35 overlap each other at the connection portion 3c, and the area where the adjacent coil conductors 36 and 37 overlap each other at the connection portion 3e.

The connection conductor 51 is positioned to extend between the coil conductor 38 and the end-surface electrode portion 41b, and electrically connects the coil conductor 38 and the end-surface electrode portion 41b. The connection conductor 51 is formed integrally with the coil conductor 38 and the external electrode 41. The connection conductor 52 is positioned to extend between the coil conductor 31 and the end-surface electrode portion 42b, and electrically connects the coil conductor 31 and the end-surface electrode portion 42b. The connection conductor 52 is formed integrally with the coil conductor 31 and the external electrode 42.

The element body 2 includes a plurality of insulator layers 20. The element body 2 is formed through laminating the plurality of insulator layers 20. A direction in which the plurality of insulator layers 20 are laminated coincides with the direction D3. In the present example, the number of the plurality of insulator layers 20 is, for example, “12”. In FIG. 3, a total of four insulator layers 20 disposed at both ends in the direction D3 are not illustrated, and eight insulator layers 20 are illustrated. The plurality of insulator layers 20 are integrated to such an extent that the boundaries between the insulator layers 20 cannot be visually recognized. Each insulator layer 20 includes, for example, a magnetic material. The magnetic material includes, for example, a Ni—Cu—Zn-based ferrite material, a Ni—Cu—Zn—Mg-based ferrite material, or a Ni—Cu-based ferrite material. The magnetic material may include an Fe alloy. Each insulator layer 20 may include a nonmagnetic material. The non-magnetic material includes, for example, a glass-ceramic material or a dielectric material. In the present example, each insulator layer 20 includes a sintered body of a green sheet containing the non-magnetic material.

As illustrated in FIG. 3, each of the external electrodes 41 and 42 includes a plurality of electrode layers 40. Each of the external electrodes 41 and 42 is formed through laminating the plurality of electrode layers 40. In the present example, the number of the plurality of electrode layers included in each of the external electrodes 41 and 42 is “8”. In each of the external electrodes 41 and 42, a direction in which the plurality of electrode layers 40 are laminated coincides with the direction D3. In each of the actual external electrodes 41 and 42, the plurality of electrode layers are integrated to such an extent that the boundaries between the electrode layers 40 cannot be visually recognized. Each electrode layer is located in a missing portion formed in a corresponding insulator layer 20 of the plurality of insulator layers 20. The missing portion formed in each of the insulator layers 20 constitutes the depression 21 of the element body 2. The element body 2 is formed with a pair of depressions 21. Each electrode layer 40 includes, for example, an electrically conductive material. The electrically conductive material includes, for example, Ag or Pd. In the present example, each electrode layer 40 includes a sintered body of a conductive paste containing electrically conductive material powders. The electrically conductive material powder includes, for example, Ag powder or Pd powder.

The connection conductor 51 includes a connection conductor layer 51a. The connection conductor 52 includes a connection conductor layer 52a. Each of the connection conductors 51 and 52 is located in a missing portion formed in a corresponding insulator layer 20 of the plurality of insulator layers 20. Each of the connection conductor layers 51a and 52a includes, for example, the same material as that of each electrode layer 40. Each of the connection conductor layers 51a and 52a includes, for example, a sintered body of a conductive paste.

As illustrated in FIG. 3, the coil 3 includes a plurality of coil conductor layers 31a, 32a, 33a, 34a, 35a 36a, 37a, and 38a. The coil 3 is formed through laminating the plurality of coil conductor layers 31a, 32a, 33a, 34a, 35a 36a, 37a, and 38a. A direction in which the plurality of coil conductor layers 31a to 38a are laminated coincides with the direction D3. In the actual coil 3, the plurality of coil conductor layers 31a to 38a are integrated to such an extent that the boundaries between the coil conductor layers 31a to 38a cannot be visually recognized. Each of the coil conductor layers 31a to 38a is located in a missing portion formed in a corresponding insulator layer 20 of the plurality of insulator layers 20. Each of the coil conductor layers 31a to 38a includes, for example, an electrically conductive material. Each of the coil conductor layers 31a to 38a includes, for example, the same material as that of each electrode layer 40. Each of the coil conductor layers 31a to 38a includes, for example, a sintered body of a conductive paste.

The coil conductor 31 includes the coil conductor layer 31a. The coil conductor 31 is arranged to constitute one end of the coil 3. The coil conductor 31 is electrically connected to the end-surface electrode portion 42b via the connection conductor 52. The coil conductor 31 is formed integrally with the connection conductor 52 and the external electrode 42. The coil conductor 31 includes a first end and a second end. The first end included in the coil conductor 31 is coupled to the connection conductor 52.

The coil conductor 32 includes the coil conductor layer 32a. The coil conductor 32 is adjacent to the coil conductor 31 in the direction D3. The coil conductor 32 overlaps the second end included in the coil conductor 31 in the direction D3, and is connected to the second end included in the coil conductor 31. The adjacent coil conductors 31 and 32 include a first conductor portion where the coil conductors 31 and 32 overlap each other in the direction D3 and are connected to each other. The first conductor portion includes a part of each of the plurality of coil conductor layers 31a and 32a. The adjacent coil conductors 31 and 32 are electrically and physically connected to each other at the first conductor portion. In the first conductor portion, the plurality of coil conductor layers 31a and 32a are integrated to such an extent that the boundaries between the plurality of coil conductor layers 31a and 32a cannot be visually recognized.

The coil conductor 33 includes the coil conductor layer 33a. The coil conductor 33 is adjacent to the coil conductor 32 in the direction D3. The coil conductor 33 includes a first end and a second end. The first end included in the coil conductor 33 overlaps the coil conductor 32 in the direction D3, and is connected to the coil conductor 32. The connection portion 3a includes an end of the coil conductor 32 and the first end included in the coil conductor 33. The connection portion 3a electrically connects the adjacent coil conductors 32 and 33. The connection portion 3a includes a part of each of the plurality of coil conductor layers 32a and 33a. The adjacent coil conductors 32 and 33 are electrically and physically connected to each other at the connection portion 3a. In the connection portion 3a, the plurality of coil conductor layers 32a and 33a are integrated to such an extent that the boundaries between the plurality of coil conductor layers 32a and 33a cannot be visually recognized.

The coil conductor 34 includes the coil conductor layer 34a. The coil conductor 34 is adjacent to the coil conductor 33 in the direction D3. The coil conductor 34 includes a first end and a second end. The first end included in the coil conductor 34 overlaps the second end included in the coil conductor 33 in the direction D3, and is connected to the second end included in the coil conductor 33. The connection portion 3b includes the second end included in the coil conductor 33 and the first end included in the coil conductor 34. The connection portion 3b electrically connects the adjacent coil conductors 33 and 34. The connection portion 3b includes a part of each of the plurality of coil conductor layers 33a and 34a. The adjacent coil conductors 33 and 34 are electrically and physically connected to each other at the connection portion 3b. In the connection portion 3b, the plurality of coil conductor layers 33a and 34a are integrated to such an extent that the boundaries between the plurality of coil conductor layers 33a and 34a cannot be visually recognized.

The coil conductor 35 includes the coil conductor layer 35a. The coil conductor 35 is adjacent to the coil conductor 34 in the direction D3. The coil conductor 35 includes a first end and a second end. The first end included in the coil conductor 35 overlaps the second end included in the coil conductor 34 in the direction D3, and is connected to the second end included in the coil conductor 34. The connection portion 3c includes the second end included in the coil conductor 34 and the first end included in the coil conductor 35. The connection portion 3c electrically connects the adjacent coil conductors 34 and 35. The connection portion 3c includes a part of each of the plurality of coil conductor layers 34a and 35a. The adjacent coil conductors 34 and 35 are electrically and physically connected to each other at the connection portion 3c. In the connection portion 3c, the plurality of coil conductor layers 34a and 35a are integrated to such an extent that the boundaries between the plurality of coil conductor layers 34a and 35a cannot be visually recognized.

The coil conductor 36 includes the coil conductor layer 36a. The coil conductor 36 is adjacent to the coil conductor 35 in the direction D3. The coil conductor 36 includes a first end and a second end. The first end included in the coil conductor 36 overlaps the second end included in the coil conductor 35 in the direction D3, and is connected to the second end included in the coil conductor 35. The connection portion 3d includes the second end included in the coil conductor 35 and the first end included in the coil conductor 36. The connection portion 3d electrically connects the adjacent coil conductors 35 and 36. The connection portion 3d includes a part of each of the plurality of coil conductor layers 35a and 36a. The adjacent coil conductors 35 and 36 are electrically and physically connected to each other at the connection portion 3d. In the connection portion 3d, the plurality of coil conductor layers 35a and 36a are integrated to such an extent that the boundaries between the plurality of coil conductor layers 35a and 36a cannot be visually recognized.

The coil conductor 37 includes the coil conductor layer 37a. The coil conductor 37 is adjacent to the coil conductor 36 in the direction D3. The coil conductor 37 includes a first end and a second end. The first end included in the coil conductor 37 overlaps the second end included in the coil conductor 36 in the direction D3, and is connected to the second end included in the coil conductor 36. The connection portion 3e includes the second end included in the coil conductor 36 and the first end included in the coil conductor 37. The connection portion 3e electrically connects the adjacent coil conductors 36 and 37. The connection portion 3e includes a part of each of the plurality of coil conductor layers 36a and 37a. The adjacent coil conductors 36 and 37 are electrically and physically connected to each other at the connection portion 3e. In the connection portion 3e, the plurality of coil conductor layers 36a and 37a are integrated to such an extent that the boundaries between the plurality of coil conductor layers 36a and 37a cannot be visually recognized.

The coil conductor 38 includes the coil conductor layer 38a. The coil conductor 38 is arranged to constitute another end of the coil 3. The coil conductor 38 is electrically connected to the end-surface electrode portion 41b via the connection conductor 51. The coil conductor 38 is formed integrally with the connection conductor 51 and the external electrode 41. The coil conductor 38 is adjacent to the coil conductor 37 in the direction D3. The coil conductor 38 includes a first end and a second end. The first end included in the coil conductor 38 is coupled to the connection conductor 51. The second end included in the coil conductor 37 overlaps the second end included in the coil conductor 38 in the direction D3, and is connected to the second end included in the coil conductor 38. The adjacent coil conductors 37 and 38 include a second conductor portion where the coil conductors 37 and 38 overlap each other in the direction D3 and are connected to each other. The second conductor portion includes a part of each of the plurality of coil conductor layers 37a and 38a. The adjacent coil conductors 37 and 38 are electrically and physically connected to each other at the second conductor portion. In the second conductor portion, the plurality of coil conductor layers 37a and 38a are integrated to such an extent that the boundaries between the plurality of coil conductor layers 37a and 38a cannot be visually recognized.

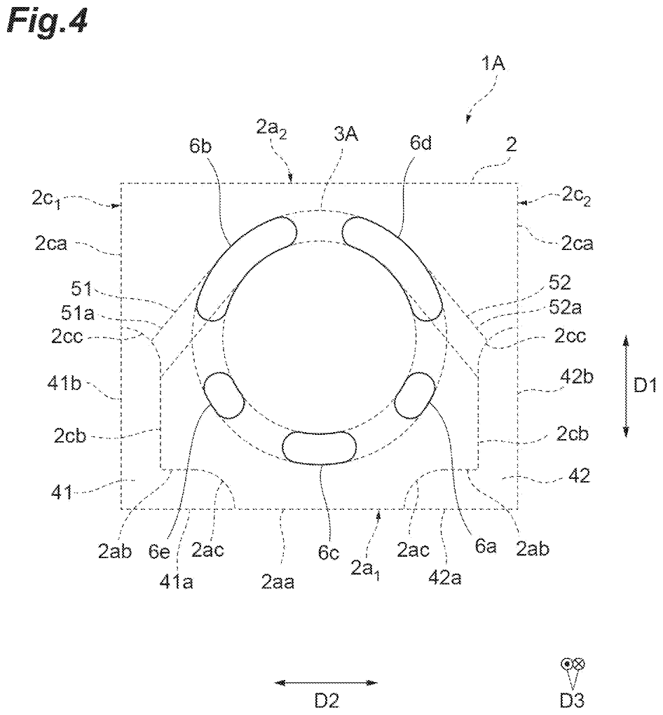

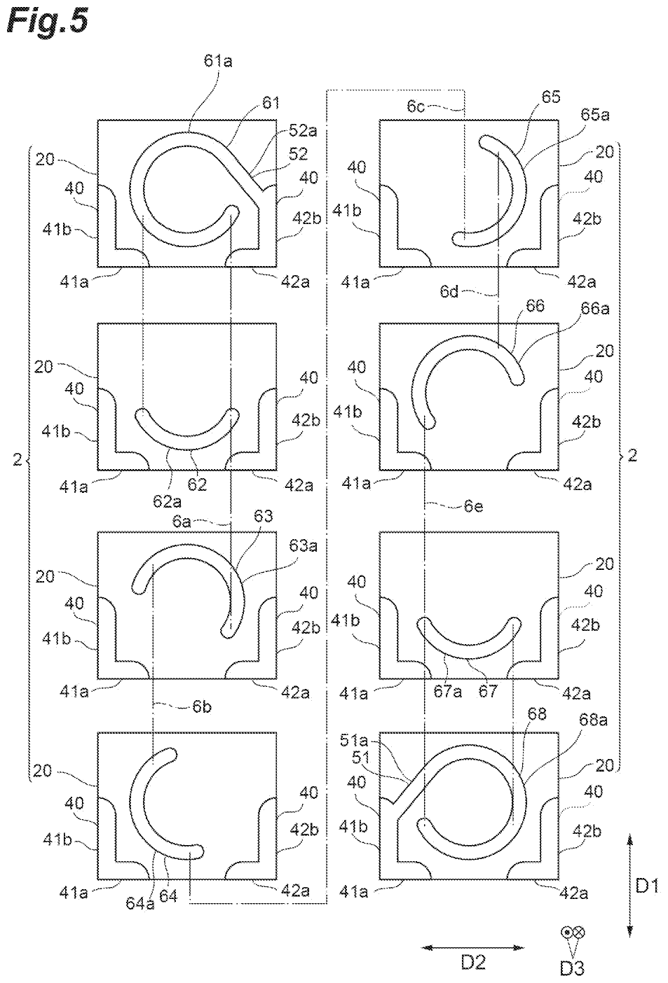

Next, a configuration of a multilayer coil component 1A according to a first modified example of the present example will be described with reference to FIGS. 4 and 5. FIG. 4 is a view illustrating a plurality of connection portions included in a multilayer coil component according to the first modified example. FIG. 5 is an exploded view schematically illustrating a configuration of the multilayer coil component according to the first modified example. The multilayer coil component 1A is generally similar to or the same as the multilayer coil component 1. However, the multilayer coil component 1A is different from the multilayer coil component 1 in a configuration of the coil. Hereinafter, differences between the multilayer coil component 1A and the multilayer coil component 1 will be mainly described.

As illustrated in FIGS. 4 and 5, the multilayer coil component 1A includes the element body 2, a coil 3A in the element body 2, the pair of external electrodes 41 and 42, and the pair of connection conductors 51 and 52. The coil 3A includes a plurality of coil conductors 61, 62, 63, 64, 65, 66, 67, and 68. The plurality of coil conductors 61 to 68 are disposed in the direction D3 and are electrically connected to each other. The coil conductor 62 is adjacent to the coil conductors 61 and 63 in the direction D3. The coil conductor 62 is located between the coil conductor 61 and the coil conductor 63 in the direction D3. The coil conductor 64 is adjacent to the coil conductors 63 and 65 in the direction D3. The coil conductor 64 is located between the coil conductor 63 and the coil conductor 65 in the direction D3. The coil conductor 66 is adjacent to the coil conductors 65 and 67 in the direction D3. The coil conductor 66 is located between the coil conductor 65 and the coil conductor 67 in the direction D3. The coil conductor 67 is adjacent to the coil conductor 68 in the direction D3. The coil conductor 67 is located between the coil conductor 66 and the coil conductor 68 in the direction D3. Each of the coil conductors 61 to 68 includes a part of an annular path in the coil 3A. Each of the coil conductors 61 to 68 has, for example, a shape in which a part of a loop is interrupted. Each of the coil conductors 61 to 68 includes a pair of ends and has a shape substantially along the annular path from the one end to the other end. The coil 3A includes eight coil conductors 61 to 68 coupled in the direction D3. The coil conductor 61 includes a coil conductor layer 61a. The coil conductor 61 has substantially the same configuration as that of the coil conductor 31 except for the shape thereof. The coil conductor 62 includes a coil conductor layer 62a. The coil conductor 62 has substantially the same configuration as that of the coil conductor 32 except for the shape thereof. The coil conductor 63 includes a coil conductor layer 63a. The coil conductor 63 has substantially the same configuration as that of the coil conductor 33 except for the shape thereof. The coil conductor 64 includes a coil conductor layer 64a. The coil conductor 64 has substantially the same configuration as that of the coil conductor 34 except for the shape thereof. The coil conductor 65 includes a coil conductor layer 65a. The coil conductor 65 has substantially the same configuration as that of the coil conductor 35 except for the shape thereof. The coil conductor 66 includes a coil conductor layer 66a. The coil conductor 66 has substantially the same configuration as that of the coil conductor 36 except for the shape thereof. The coil conductor 67 includes a coil conductor layer 67a. The coil conductor 67 has substantially the same configuration as that of the coil conductor 37 except for the shape thereof. The coil conductor 68 includes a coil conductor layer 68a. The coil conductor 68 has substantially the same configuration as that of the coil conductor 38 except for the shape thereof. The number of turns of each of the coil conductors 61 to 68 is, for example, at least approximately “⅖”. The number of turns of the coil 3A is, for example, approximately “3.5”. The coil 3A has substantially the same configuration as that of the coil 3 except for the shape thereof.

The coil 3A includes the plurality of coil conductor layers 61a, 62a, 63a, 64a, 65a 66a, 67a, and 68a. The coil 3A is formed through laminating the plurality of coil conductor layers 61a, 62a, 63a, 64a, 65a 66a, 67a, and 68a. A direction in which the plurality of coil conductor layers 61a to 68a are laminated coincides with the direction D3. In the actual coil 3A, the plurality of coil conductor layers 61a to 68a are integrated to such an extent that the boundaries between the coil conductor layers 61a to 68a cannot be visually recognized. Each of the coil conductor layers 61a to 68a is located in a missing portion formed in a corresponding insulator layer 20 of the plurality of insulator layers 20. Each of the coil conductor layers 61a to 68a includes, for example, an electrically conductive material. Each of the coil conductor layers 61a to 68a includes, for example, the same material as that of each of the coil conductor layers 31a to 38a. Each of the coil conductor layers 61a to 68a includes, for example, a sintered body of a conductive paste.

As illustrated in FIG. 4, the coil 3A includes a plurality of connection portions 6a, 6b, 6c, 6d, and 6e. In each of the connection portions 6a to 6e, adjacent coil conductors of the plurality of coil conductors 62 to 67 are electrically connected to each other, and the adjacent coil conductors overlap each other when viewed from the direction D3. In the connection portion 6a, the coil conductor 62 and the coil conductor 63 are continuous with each other. In the connection portion 6b, the coil conductor 63 and the coil conductor 64 are continuous with each other. In the connection portion 6c, the coil conductor 64 and the coil conductor 65 are continuous with each other. In the connection portion 6d, the coil conductor 65 and the coil conductor 66 are continuous with each other. In the connection portion 6e, the coil conductor 66 and the coil conductor 67 are continuous with each other. In FIG. 4, elements other than the plurality of connection portions 6a, 6b, 6c, 6d, and 6e are indicated by broken lines in order to emphasize the plurality of connection portions 6a, 6b, 6c, 6d, and 6e.

When viewed from the direction D3, the coil 3A has a substantially circular shape. For example, when viewed from the direction D3, each of the connecting portions 6a to 6e is located on a circumference of the substantially circular shape that is the shape of the coil 3A. When viewed from the direction D3, each of the connecting portions 6b and 6d is closer to the main surface 2a₂ than a center of the substantially circular shape that is the shape of the coil 3A. When viewed from the direction D3, each of the connecting portions 6a, 6c, and 6e is closer to the main surface 2a₁ than the center of the substantially circular shape that is the shape of the coil 3A.

The connection portions 6b and 6d are more distant from the main-surface electrode portions 41a and 42a than the connection portions 6a, 6c, and 6e. The connection portions 6a, 6c, and 6e are closer to the main-surface electrode portions 41a and 42a than the connection portions 6b and 6d. In the direction D1, the connection portions 6b and 6d may be closer to the main surface 2a₂ than the end-surface electrode portions 41b and 42b. For example, at least one of the connection portions 6a, 6c, and 6e includes a first connection portion. For example, at least one of the connection portions 6b and 6d includes a second connection portion. Each of the connection portions 6a, 6c, and 6e may be included in a first group. Each of the connection portions 6b and 6d may be included in a second group. Areas of the connection portions 6b and 6d when viewed from the direction D3 are larger than areas of the connection portions 6a, 6c, and 6e when viewed from the direction D3. An area where the adjacent coil conductors 63 and 64 overlap each other at the connecting portion 6b is larger than an area where the adjacent coil conductors 62 and 63 overlap each other at the connection portion 6a, larger than an area where the adjacent coil conductors 64 and 65 overlap each other at the connection portion 6c, and larger than an area where the adjacent coil conductors 66 and 67 overlap each other at the connection portion 6e. An area where the adjacent coil conductors 65 and 66 overlap each other at the connection portion 6d are larger than the area where the adjacent coil conductors 62 and 63 overlap each other at the connection portion 6a, larger than the area where the adjacent coil conductors 64 and 65 overlap each other at the connection portion 6c, and larger than the area where the adjacent coil conductors 66 and 67 overlap each other in the connection portion 6e. The areas of the connection portions 6a and 6e when viewed from the direction D3 are smaller than the area of the connection portion 6c when viewed from the direction D3. The area where the adjacent coil conductors 62 and 63 overlap each other at the connection portion 6a is smaller than the area where the adjacent coil conductors 64 and 65 overlap each other at the connection portion 6c. The area where the adjacent coil conductors 66 and 67 overlap each other at the connection portion 6e is smaller than the area where the adjacent coil conductors 64 and 65 overlap each other at the connection portion 6c. For example, when the area where the adjacent coil conductors overlap each other at each of the connection portions 6a, 6c, and 6e includes a first areas, the area where the adjacent coil conductors overlap each other at each of the connection portions 6b and 6d includes a second areas.

The connection portion 6a is adjacent to the main-surface electrode portion 42a and the end-surface electrode portion 42b. The connection portion 6e is adjacent to the main-surface electrode portion 41a and the end-surface electrode portion 41b. Each of the connection portions 6a and 6e may be included in a third group. The connection portion 6c is adjacent to the region 2aa. The connection portion 6c is adjacent to the end-surface electrode portion 41b. The connection portion 6c may be included in the third group. Each of the connection portions 6b and 6d may be included in a fourth group. A sum of the area where the adjacent coil conductors 63 and 64 overlap each other at the connection portion 6b and the area where the adjacent coil conductors 65 and 66 overlap each other at the connection portion 6d is larger than a sum of the area where the adjacent coil conductors 62 and 63 overlap each other at the connection portion 6a and the area where the adjacent coil conductors 66 and 67 overlap each other at the connection portion 6e. The sum of the area where the adjacent coil conductors 63 and 64 overlap each other at the connection portion 6b and the area where the adjacent coil conductors 65 and 66 overlap each other at the connecting portion 6d is larger than a sum of the area where the adjacent coil conductors 62 and 63 overlap each other at the connection portion 6a, the area where the adjacent coil conductors 64 and 65 overlap each other at the connection portion 6c, and the area where the adjacent coil conductors 66 and 67 overlap each other at the connection portion 6e. The connection portion 6a has substantially the same configuration as that of the connection portion 3a except for the shape thereof. The connection portion 6a and the connection portion 3a may be different in size. The connection portion 6b has substantially the same configuration as that of the connection portion 3b except for the shape thereof. The connection portion 6b and the connection portion 3b may be different in size. The connection portion 6c has substantially the same configuration as that of the connection portion 3c except for the shape thereof. The connection portion 6c and the connection portion 3c may be different in size. The connection portion 6d has substantially the same configuration as that of the connection portion 3d except for the shape thereof. The connection portion 6d and the connection portion 3d may be different in size. The connection portion 6e has substantially the same configuration as that of the connection portion 3e except for the shape thereof. The connection portion 6e and the connection portion 3e may be different in size.

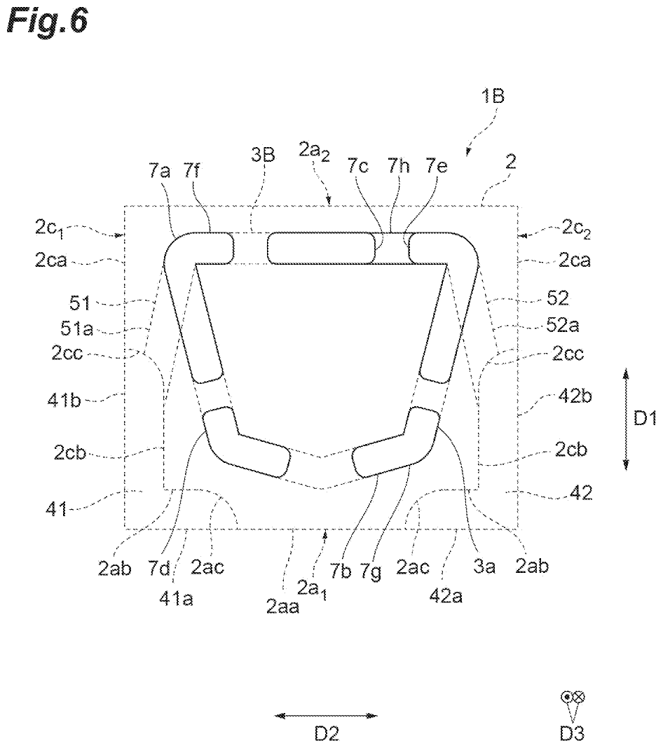

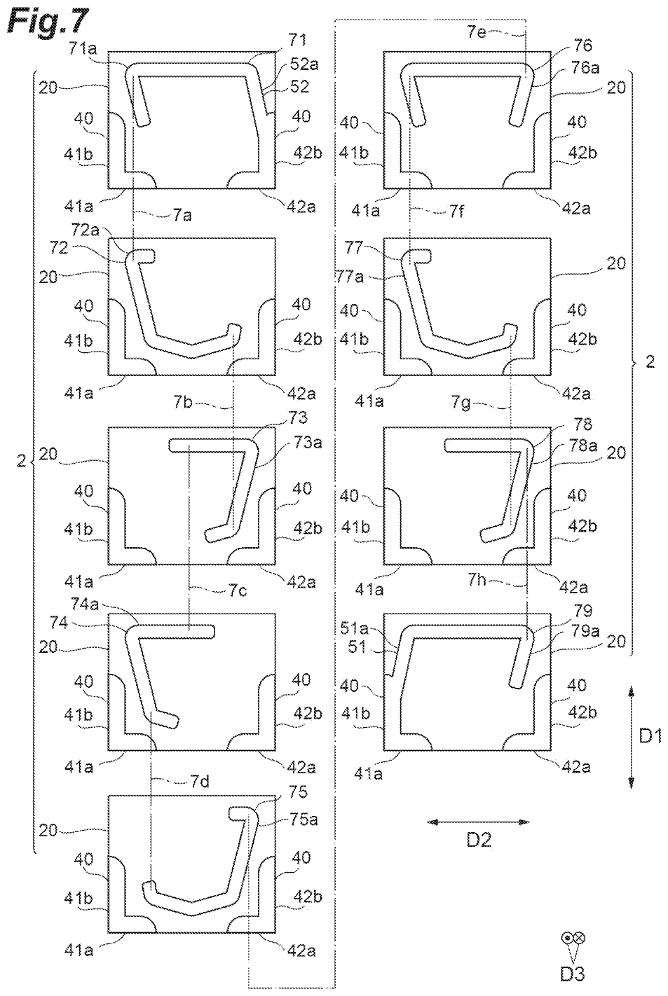

Next, a configuration of a multilayer coil component 1B according to a second modified example of the present example will be described with reference to FIGS. 6 and 7. FIG. 6 is a view illustrating a plurality of connection portions included in a multilayer coil component according to the second modified example. FIG. 7 is an exploded view schematically illustrating a configuration of the multilayer coil component according to the second modified example. The multilayer coil component 1B is generally similar to or the same as the multilayer coil component 1. However, the multilayer coil component 1B is different from the multilayer coil component 1 in a configuration of the coil. Hereinafter, differences between the multilayer coil component 1B and the multilayer coil component 1 will be mainly described.

As illustrated in FIGS. 6 and 7, the multilayer coil component 1B includes the element body 2, a coil 3B in the element body 2, the pair of external electrodes 41 and 42, and the pair of connection conductors 51 and 52. The coil 3B includes a plurality of coil conductors 71, 72, 73, 74, 76, 77, 78, and 79. The plurality of coil conductors 71 to 79 are disposed in the direction D3 and are electrically connected to each other. The coil conductor 72 is adjacent to the coil conductors 71 and 73 in the direction D3. The coil conductor 72 is located between the coil conductor 71 and the coil conductor 73 in the direction D3. The coil conductor 74 is adjacent to the coil conductors 73 and 75 in the direction D3. The coil conductor 74 is located between the coil conductor 73 and the coil conductor 75 in the direction D3. The coil conductor 76 is adjacent to the coil conductors 75 and 77 in the direction D3. The coil conductor 76 is located between the coil conductor 75 and the coil conductor 77 in the direction D3. The coil conductor 78 is adjacent to the coil conductors 77 and 79 in the direction D3. The coil conductor 78 is located between the coil conductor 77 and the coil conductor 79 in the direction D3. Each of the coil conductors 71 to 79 includes a part of an annular path in the coil 3B. Each of the coil conductors 71 to 79 has, for example, a shape in which a part of a loop is interrupted. Each of the coil conductors 71 to 79 includes a pair of ends and has a shape substantially along the annular path from the one end to the other end. The coil 3B includes nine coil conductors 71 to 79 coupled in the direction D3. The coil conductors 71, 72, 73, 74, 75, 76, 77, 78, and 79 includes coil conductor layer 71a, 72a, 73a, 74a, 75a, 76a, 77a, 78a, and 79a, respectively. The number of turns of the coil 3B is, for example, approximately “3.5”. In the second modified example, the number of the plurality of insulator layers 20 is, for example, “13”. In FIG. 7, a total of four insulator layers 20 disposed at both ends in the direction D3 are not illustrated, and nine insulator layers are illustrated.

The coil 3B includes the plurality of coil conductor layers 71a, 72a, 73a, 74a, 75a 76a, 77a, 78a, and 79a. The coil 3B is formed through laminating the plurality of coil conductor layers 71a, 72a, 73a, 74a, 75a 76a, 77a, 78a, and 79a. A direction in which the plurality of coil conductor layers 71a to 79a are laminated coincides with the direction D3. In the actual coil 3B, the plurality of coil conductor layers 71a to 79a are integrated to such an extent that the boundaries between the coil conductor layers 71a to 79a cannot be visually recognized. Each of the coil conductor layers 71a to 79a is located in a missing portion formed in a corresponding insulator layer 20 of the plurality of insulator layers 20. Each of the coil conductor layers 71a to 79a includes, for example, an electrically conductive material. Each of the coil conductor layers 71a to 79a includes, for example, the same material as that of each of the coil conductor layers 31a to 38a. Each of the coil conductor layers 71a to 79a includes, for example, a sintered body of a conductive paste.

As illustrated in FIG. 6, the coil 3B includes a plurality of connection portions 7a, 7b, 7c, 7d, 7e, 7f, 7g, and 7h. In each of the connection portions 7a, 7b, 7c, 7d, 7e, 7f, 7g, and 7h, adjacent coil conductors of the plurality of coil conductors 71 to 79 are electrically connected to each other, and the adjacent coil conductors overlap each other when viewed from the direction D3. In the connection portion 7a, the coil conductor 71 and the coil conductor 72 are continuous with each other. In the connection portion 7b, the coil conductor 72 and the coil conductor 73 are continuous with each other. In the connection portion 7c, the coil conductor 73 and the coil conductor 74 are continuous with each other. In the connection portion 7d, the coil conductor 74 and the coil conductor 75 are continuous with each other. In the connection portion 7e, the coil conductor 75 and the coil conductor 76 are continuous with each other. In the connection portion 7f, the coil conductor 76 and the coil conductor 77 are continuous with each other. In the connection portion 7g, the coil conductor 77 and the coil conductor 78 are continuous with each other. In the connection portion 7h, the coil conductor 78 and the coil conductor 79 are continuous with each other. In FIG. 6, elements other than the plurality of connection portions 7a, 7b, 7c, 7d, 7e, 7f, 7g, and 7h are indicated by broken lines in order to emphasize the plurality of connection portions 7a, 7b, 7c, 7d, 7e, 7f, 7g, and 7h.

When viewed from the direction D3, the coil 3B has a substantially pentagonal shape. For example, when viewed from the direction D3, each of the connecting portions 7a to 7h is located on a corresponding side of a plurality of sides of the substantially pentagonal shape that is the shape of the coil 3B, similarly to each of the connecting portions 3a to 3e. The plurality of sides includes one long side, a pair of first short sides, and a pair of second short sides. The long side is adjacent to the main surface 2a₂ and extends along the direction D2. Each of the pair of first short sides extends from a corresponding end of both ends of the long side toward the main-surface electrode portions 41a and 42a. Each of the pair of second short sides extends from an end of a corresponding first short side of the pair of first short sides toward the main surface 2a₁. The long side is longer than each first short side. Each first short side is longer than each second short side. Each first short side is adjacent to a corresponding electrode portion of the end-surface electrode portions 41b and 42b. Each second short side is adjacent to a corresponding electrode portion of the main-surface electrode portions 41a and 42a. When viewed from the direction D3, each of the connection portions 7a, 7e, 7f, and 7h extends along a part of the long side and a part of the corresponding first short side of the pair of first short sides. When viewed from the direction D3, each of the connection portions 7b, 7d, and 7g extends along a part of the corresponding first short side of the pair of first short sides and a part of the corresponding second short side of the pair of second short sides. When viewed from the direction D3, the connection portion 7c extends along the long side. When viewed from the direction D3, the connection portions 7a and 7f overlap each other. When viewed from the direction D3, the connection portions 7b and 7g overlap each other. When viewed from the direction D3, the connection portions 7e and 7h overlap each other.

The connection portions 7a, 7c, 7e, 7f, and 7h are more distant from the main-surface electrode portions 41a and 42a than the connection portions 7b, 7d, and 7g. The connection portions 7b, 7d, and 7g are closer to the main-surface electrode portions 41a and 42a than the connection portions 7a, 7c, 7e, 7f, and 7h. In the direction D1, the connection portions 7a, 7c, 7e, 7f, and 7h may be closer to the main surface 2a₂ than the end-surface electrode portions 41b and 42b. For example, at least one of the connection portions 7b, 7d, and 7g includes a first connection portion. For example, at least one of the connection portions 7a, 7e, 7f, and 7h includes a second connection portion. Each of the connection portions 7b, 7d, and 7g may be included in a first group. Each of the connection portions 7a, 7e, 7f, and 7h may be included in a second group. The connection portion 7c may include the second connection portion. The connection portion 7c may be included in the second group.

Areas of the connection portions 7a, 7e, 7f, and 7h when viewed from the direction D3 are larger than areas of the connection portions 7b, 7d, and 7g when viewed from the direction D3. An area where the adjacent coil conductors 71 and 72 overlap each other at the connecting portion 7a is larger than an area where the adjacent coil conductors 72 and 73 overlap each other at the connection portion 7b, larger than an area where the adjacent coil conductors 74 and 75 overlap each other at the connection portion 7d, and larger than an area where the adjacent coil conductors 77 and 78 overlap each other at the connection portion 7g. An area where the adjacent coil conductors 75 and 76 overlap each other at the connecting portion 7e is larger than the area where the adjacent coil conductors 72 and 73 overlap each other at the connection portion 7b, larger than the area where the adjacent coil conductors 74 and 75 overlap each other at the connection portion 7d, and larger than the area where the adjacent coil conductors 77 and 78 overlap each other at the connection portion 7g. An area where the adjacent coil conductors 76 and 77 overlap each other at the connecting portion 7f is larger than the area where the adjacent coil conductors 72 and 73 overlap each other at the connection portion 7b, larger than the area where the adjacent coil conductors 74 and 75 overlap each other at the connection portion 7d, and larger than the area where the adjacent coil conductors 77 and 78 overlap each other at the connection portion 7g. An area where the adjacent coil conductors 78 and 79 overlap each other at the connecting portion 7h is larger than the area where the adjacent coil conductors 72 and 73 overlap each other at the connection portion 7b, larger than the area where the adjacent coil conductors 74 and 75 overlap each other at the connection portion 7d, and larger than the area where the adjacent coil conductors 77 and 78 overlap each other at the connection portion 7g. A sum of the area where the adjacent coil conductors 71 and 72 overlap each other at the connection portion 7a and the area where the adjacent coil conductors 76 and 77 overlap each other at the connection portion 7f is larger than a sum of the area where the adjacent coil conductors 72 and 73 overlap each other at the connection portion 7b and the area where the adjacent coil conductors 77 and 78 overlap each other at the connection portion 7g. A sum of the area where the adjacent coil conductors 75 and 76 overlap each other at the connection portion 7e and the area where the adjacent coil conductors 78 and 79 overlap each other at the connection portion 7h is larger than the sum of the area where the adjacent coil conductors 72 and 73 overlap each other at the connection portion 7b and the area where the adjacent coil conductors 77 and 78 overlap each other at the connection portion 7g. For example, when the area where the adjacent coil conductors overlap each other at each of the connection portions 7b, 7d, and 7 includes a first areas, the area where the adjacent coil conductors overlap each other at each of the connection portions 7a, 7e, 7f, and 7h includes a second areas.

Each of the connection portions 7b and 7g is adjacent to the main-surface electrode portion 42a and the end-surface electrode portion 42b.

The connection portion 7d is adjacent to the main-surface electrode portion 41a and the end-surface electrode portion 41b. Each of the connection portions 7b, 7d, and 7g may be included in a third group. Each of the connection portions 7a, 7e, 7f, and 7h may be included in a fourth group. A sum of the area where the adjacent coil conductors 71 and 72 overlap each other at the connection portion 7a, the area where the adjacent coil conductors 76 and 77 overlap each other at the connection portion 7f, the area where the adjacent coil conductors 75 and 76 overlap each other at the connection portion 7e, and the area where the adjacent coil conductors 78 and 79 overlap each other at the connection portion 7h is larger than a sum of the area where the adjacent coil conductors 72 and 73 overlap each other at the connection portion 7b, the area where the adjacent coil conductors 74 and 75 overlap each other at the connection portion 7d, and the area where the adjacent coil conductors 77 and 78 overlap each other at the connection portion 7g. The connection portion 7c may be included in the fourth group.

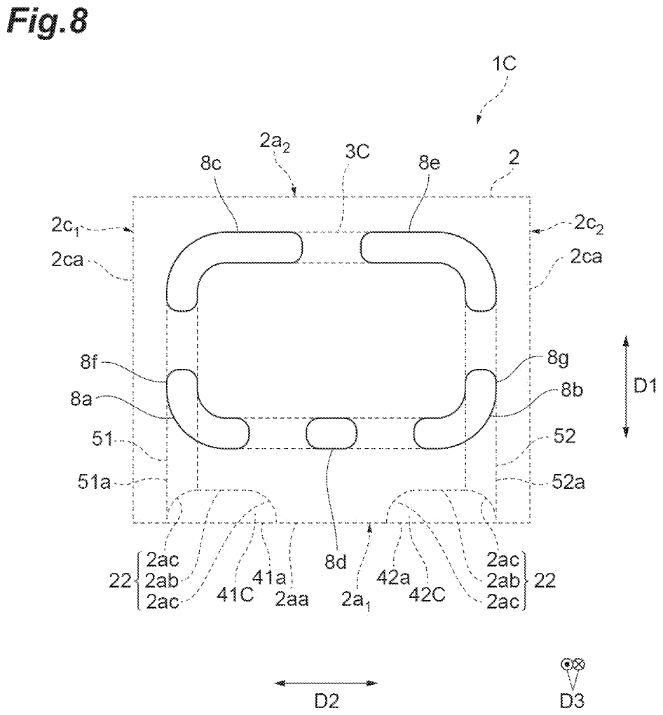

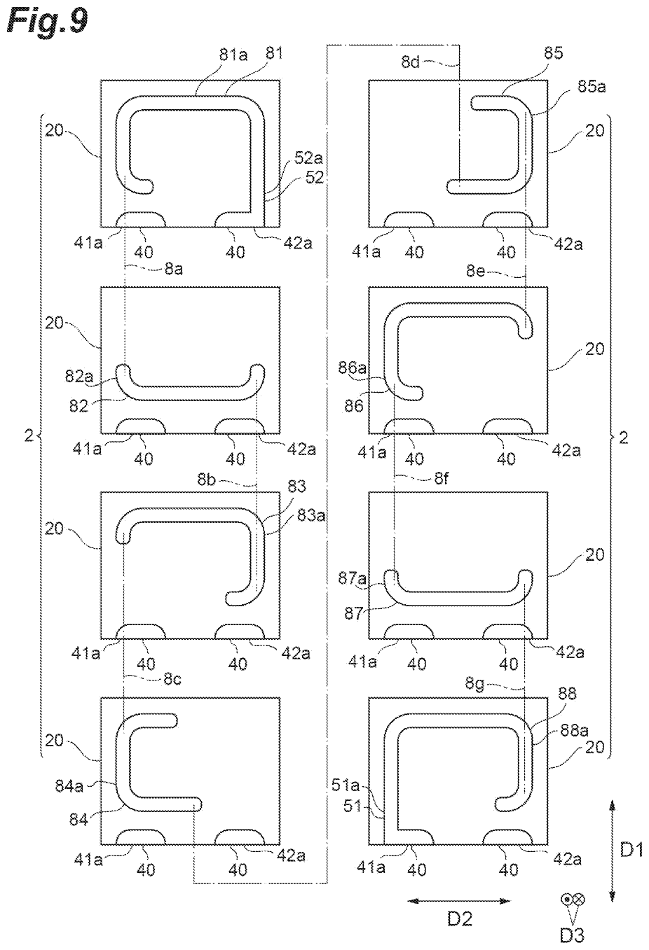

Next, a configuration of a multilayer coil component 1C according to a third modified example of the present example will be described with reference to FIGS. 8 and 9. FIG. 8 is a view illustrating a plurality of connection portions included in a multilayer coil component according to the third modified example. FIG. 9 is an exploded view schematically illustrating a configuration of the multilayer coil component according to the third modified example. The multilayer coil component 1C is generally similar to or the same as the multilayer coil component 1. However, the multilayer coil component 1C is different from the multilayer coil component 1 in a configuration of the coil and the pair of external electrodes. Hereinafter, differences between the multilayer coil component 1C and the multilayer coil component 1 will be mainly described.

As illustrated in FIGS. 8 and 9, the multilayer coil component 1C includes the element body 2, a coil 3C in the element body 2, the pair of external electrodes 41C and 42C, and the pair of connection conductors 51 and 52. The coil 3C includes a plurality of coil conductors 81, 82, 83, 84, 85, 86, 87, and 88. The plurality of coil conductors 81 to 88 are disposed in the direction D3 and are electrically connected to each other. The coil conductor 82 is adjacent to the coil conductors 81 and 83 in the direction D3. The coil conductor 82 is located between the coil conductor 81 and the coil conductor 83 in the direction D3. The coil conductor 84 is adjacent to the coil conductors 83 and 85 in the direction D3. The coil conductor 84 is located between the coil conductor 83 and the coil conductor 85 in the direction D3. The coil conductor 86 is adjacent to the coil conductors 85 and 87 in the direction D3. The coil conductor 86 is located between the coil conductor 85 and the coil conductor 87 in the direction D3. The coil conductor 87 is adjacent to the coil conductors 86 and 88 in the direction D3. The coil conductor 87 is located between the coil conductor 86 and the coil conductor 88 in the direction D3. Each of the coil conductors 81 to 88 includes a part of an annular path in the coil 3C. Each of the coil conductors 81 to 88 has, for example, a shape in which a part of a loop is interrupted. Each of the coil conductors 81 to 88 includes a pair of ends and has a shape substantially along the annular path from the one end to the other end. The coil 3C includes eight coil conductors 81 to 88 coupled in the direction D3. The coil conductors 81, 82, 83, 84, 85, 86, 87, and 88 includes coil conductor layer 81a, 82a, 83a, 84a, 85a, 86a, 87a, and 88a, respectively. The number of turns of each of the coil conductors 81 to 88 is, for example, at least approximately “⅖”. The number of turns of the coil 3C is, for example, approximately “3.5”. In the third modified example, the number of the plurality of insulator layers 20 is, for example, “12”. In FIG. 9, a total of four insulator layers 20 disposed at both ends in the direction D3 are not illustrated, and eight insulator layers 20 are illustrated.

The coil 3C includes the plurality of coil conductor layers 81a, 82a, 83a, 84a, 85a 86a, 87a, and 88a. The coil 3C is formed through laminating the plurality of coil conductor layers 81a, 82a, 83a, 84a, 85a 86a, 87a, and 88a. A direction in which the plurality of coil conductor layers 81a to 88a are laminated coincides with the direction D3. In the actual coil 3C, the plurality of coil conductor layers 81a to 88a are integrated to such an extent that the boundaries between the coil conductor layers 81a to 88a cannot be visually recognized. Each of the coil conductor layers 81a to 88a is located in a missing portion formed in a corresponding insulator layer 20 of the plurality of insulator layers 20. Each of the coil conductor layers 81a to 88a includes, for example, an electrically conductive material. Each of the coil conductor layers 81a to 88a includes, for example, the same material as that of each of the coil conductor layers 31a to 38a. Each of the coil conductor layers 81a to 88a includes, for example, a sintered body of a conductive paste.

As illustrated in FIG. 8, the coil 3C includes a plurality of connection portions 8a, 8b, 8c, 8d, 8e, 8f, and 8g. In each of the connection portions 8a, 8b, 8c, 8d, 8e, 8f, and 8g, adjacent coil conductors of the plurality of coil conductors 81 to 88 are electrically connected to each other, and the adjacent coil conductors overlap each other when viewed from the direction D3. In the connection portion 8a, the coil conductor 81 and the coil conductor 82 are continuous with each other. In the connection portion 8b, the coil conductor 82 and the coil conductor 83 are continuous with each other. In the connection portion 8c, the coil conductor 83 and the coil conductor 84 are continuous with each other. In the connection portion 8d, the coil conductor 84 and the coil conductor 85 are continuous with each other. In the connection portion 8e, the coil conductor 85 and the coil conductor 86 are continuous with each other. In the connection portion 8f, the coil conductor 86 and the coil conductor 87 are continuous with each other. In the connection portion 8g, the coil conductor 87 and the coil conductor 88 are continuous with each other. In FIG. 8, elements other than the plurality of connection portions 8a, 8b, 8c, 8d, 8e, 8f, and 8g are indicated by broken lines in order to emphasize the plurality of connection portions 8a, 8b, 8c, 8d, 8e, 8f, and 8g.

When viewed from the direction D3, the coil 3C has a substantially rectangular shape. For example, when viewed from the direction D3, each of the connecting portions 8a to 8g is located on a corresponding side of a plurality of sides of the substantially rectangular shape that is the shape of the coil 3C. The plurality of sides includes a first long side, a second long side, and a pair of short sides. The first long side is adjacent to the main surface 2a₂ and extends along the direction D2. The second long side is adjacent to the main surface 2a₁ and extends along the direction D2. The pair of short sides extends along the direction D1 and couple the first long side and the second long side. When viewed from the direction D3, the connection portions 8a and 8f overlap each other. When viewed from the direction D3, the connection portions 8b and 8g overlap each other. When viewed from the direction D3, each of the connecting portions 8c and 8e is closer to the main surface 2a₂ than a center of the substantially rectangular shape that is the shape of the coil 3C. When viewed from the direction D3, each of the connecting portions 8a, 8b, 8d, 8f, and 8g is closer to the main surface 2a₁ than the center of the substantially rectangular shape that is the shape of the coil 3C. When viewed from the direction D3, each of the connection portions 8c and 8e extends along a part of the first long side and a part of a corresponding short side of the pair of short sides. When viewed from the direction D3, each of the connection portions 8a, 8b, 8f, and 8g extends along a part of the second long side and a part of a corresponding short side of the pair of short sides. When viewed from the direction D3, the connection portion 8d extends along a part of the second long side. When viewed from the direction D3, the connecting portions 8a and 8f are adjacent to the main-surface electrode portion 41a. When viewed from the direction D3, the connecting portions 8b and 8g are adjacent to the main-surface electrode portion 42a.

In the multilayer coil component 1C, the surface of the element body 2 is exposed from the pair of external electrodes 41C and 42C except for the main surfaces 2a₁. The pair of external electrodes 41C and 42C are disposed only on the main surface 2a₁. In the multilayer coil component 1C, the element body 2 is formed with a pair of depressions 22. A region defining the depression 22 includes the region 2ab and the pair of step regions 2ac. The depression 22 is open only at the main surface 2a₁.

The pair of external electrodes 41C and 42C do not include the end-surface electrode portion. As illustrated in FIG. 8, in the multilayer coil component 1C, each of the main-surface electrode portions 41a and 42a is disposed on the pair of step regions 2ac and the region 2ab. For example, surfaces of the main-surface electrode portions 41a and 42a are flush with the surfaces of the region 2aa.

In the multilayer coil component 1C, the connection conductor 51 is positioned to extend between the coil conductor 88 and the main-surface electrode portion 41a, and electrically connects the coil conductor 88 and the main-surface electrode portion 41a. The connection conductor 51 is formed integrally with the coil conductor 88 and the external electrode 41. The connection conductor 52 is positioned to extend between the coil conductor 81 and the main-surface electrode portion 42a, and electrically connects the coil conductor 81 and the main-surface electrode portion 42a. The connection conductor 52 is formed integrally with the coil conductor 81 and the external electrode 42.

The connection portions 8c and 8e are more distant from the main-surface electrode portions 41a and 42a than the connection portions 8a, 8b, 8d, 8f, and 8g. The connection portions 8a, 8b, 8d, 8f, and 8g are closer to the main-surface electrode portions 41a and 42a than the connection portions 8c and 8e. For example, at least one of the connection portions 8a, 8b, 8d, 8f, and 8g includes a first connection portion. For example, at least one of the connection portions 8c and 8e includes a second connection portion. Areas of the connection portions 8c and 8e when viewed from the direction D3 are larger than areas of the connection portions 8a, 8b, 8d, 8f, and 8g when viewed from the direction D3. An area where the adjacent coil conductors 83 and 84 overlap each other at the connecting portion 8c is larger than an area where the adjacent coil conductors 81 and 82 overlap each other at the connection portion 8a, larger than an area where the adjacent coil conductors 82 and 83 overlap each other at the connection portion 8b, larger than an area where the adjacent coil conductors 84 and 85 overlap each other at the connection portion 8d, larger than an area where the adjacent coil conductors 86 and 87 overlap each other at the connection portion 8f, and larger than an area where the adjacent coil conductors 87 and 88 overlap each other at the connection portion 8g. An area where the adjacent coil conductors 85 and 86 overlap each other at the connecting portion 8e is larger than the area where the adjacent coil conductors 81 and 82 overlap each other at the connection portion 8a, larger than the area where the adjacent coil conductors 82 and 83 overlap each other at the connection portion 8b, larger than the area where the adjacent coil conductors 84 and 85 overlap each other at the connection portion 8d, larger than the area where the adjacent coil conductors 86 and 87 overlap each other at the connection portion 8f, and larger than the area where the adjacent coil conductors 87 and 88 overlap each other at the connection portion 8g. The area of the connection portion 8d when viewed from the direction D3 is smaller than the areas of the connection portions 8a, 8b, 8f, and 8g when viewed from the direction D3. The area where the adjacent coil conductors 84 and 85 overlap each other at the connection portion 8d is smaller than the area where the adjacent coil conductors 81 and 82 overlap each other at the connection portion 8a, smaller than the area where the adjacent coil conductors 82 and 83 overlap each other at the connection portion 8b, smaller than the area where the adjacent coil conductors 86 and 87 overlap each other at the connection portion 8f, and smaller than the area where the adjacent coil conductors 87 and 88 overlap each other at the connection portion 8g. For example, when the area where the adjacent coil conductors overlap each other at each of the connection portions 8a, 8b, 8d, 8f, and 8g includes a first areas, the area where the adjacent coil conductors overlap each other at each of the connection portions 8c and 8e includes a second areas.

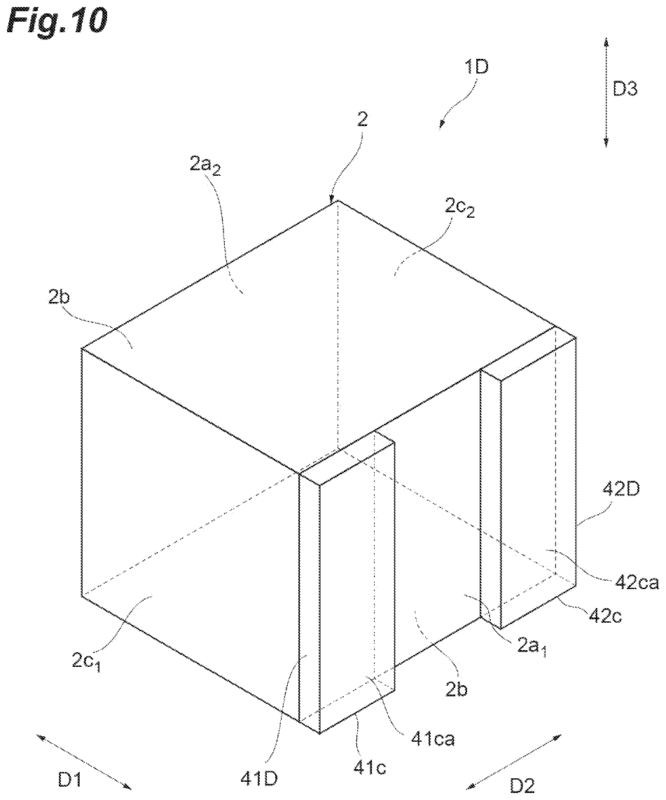

Next, a configuration of a multilayer coil component 1D according to a fourth modified example of the present example will be described with reference to FIG. 10. FIG. 10 is a perspective view illustrating a multilayer coil component according to the fourth modified example. The multilayer coil component 1D is generally similar to or the same as the multilayer coil component 1. However, the multilayer coil component 1D is different from the multilayer coil component 1 in a configuration of the pair of external electrodes. Hereinafter, differences between the multilayer coil component 1D and the multilayer coil component 1 will be mainly described.

The multilayer coil component 1D includes the element body 2, a coil 3C in the element body 2, the pair of external electrodes 41D and 42D, and the pair of connection conductors 51 and 52. In FIG. 10, illustration of the coil 3 and the pair of connection conductors 51 and 52 is omitted. In the multilayer coil component 1D, the element body 2 may be formed with no depression. The external electrode 41D includes the main-surface electrode portion 41a, and the external electrode 42D includes the main-surface electrode portion 42a. When viewed from the direction D1, the external electrodes 41D and 42D have a substantially rectangular shape. The external electrodes 41D and 42D are disposed at both ends of the main surface 2a₁ in the direction D2. The external electrode 41D includes a surface in contact with the main surface 2a₁ and a surface 41ca opposing the surface in contact with the main surface 2a₁ in the direction D1. The external electrode 42D includes a surface in contact with the main surface 2a₁ and a surface 42ca opposing the surface in contact with the main surface 2a₁ in the direction D1. The surfaces 41ca and 42ca are exposed from the element body 2. The main-surface electrode portions 41a and 42a is disposed on the main surface 2a₁. Each of the main-surface electrode portions 41a and 42a is exposed from the element body 2 except for the surface in contact with the element body 2.

In the multilayer coil component 1, the area where the adjacent coil conductors overlap each other at each of the connecting portions 3b and 3d is larger than the area where the adjacent coil conductors overlap each other at each of the connecting portions 3a, 3c, and 3e. The multilayer coil component 1 can increase a contact area between the adjacent coil conductors at each of the connecting portions 3b and 3d. Therefore, the multilayer coil component 1 can reduce direct current resistance.

An increase in the area where the adjacent coil conductors overlap each other at each of the connecting portions 3b and 3d may increase areas where the connecting portions 3b and 3d and the main-surface electrode portions 41a and 42a oppose each other. An increase in the areas where the connecting portions 3b and 3d and the main-surface electrode portions 41a and 42a oppose each other may increase stray capacitance between the connecting portions 3b and 3d and the main-surface electrode portions 41a and 42a. In the multilayer coil component 1, the connecting portions 3b and 3d are more distant from the main-surface electrode portions 41a and 42a than the connecting portions 3a, 3c, and 3e. Therefore, even when the area where the adjacent coil conductors overlap each other at each of the connecting portions 3b and 3d increase, the multilayer coil component 1 can prevent an increase in the stray capacitance.

Similarly, each of the multilayer coil components 1A, 1B, 1C, and 1D can reduce direct current resistance and prevent an increase in stray capacitance.

The element body 2 may include a main surface 2a₁. The main surface 2a₁ may include the region 2aa and the pair of regions 2ab. Each of the main-surface electrode portions 41a and 42a may be disposed on a corresponding region 2ab of the pair of regions 2ab.

In the multilayer coil components 1, 1A, 1B, and 1C, the main-surface electrode portions 41a and 42a are disposed on the corresponding regions 2ab of the pair of regions 2ab. The multilayer coil components 1, 1A, 1B, and 1C can increase contact areas between the main-surface electrode portions 41a and 42a and the element body 2. Therefore, the multilayer coil components 1, 1A, 1B, and 1C can improve adhesion strength between the main-surface electrode portions 41a and 42a and the element body 2.

The element body 2 may include the pair of end surfaces 2c₁ and 2c₂. The external electrode 41 may include the end-surface electrode portion 41b, and the external electrode 42 may include the end-surface electrode portion 42b.

In the multilayer coil component 1, 1A, and 1B, the external electrode 41 includes the end-surface electrode portion 41b, and the external electrode 42 includes the end-surface electrode portion 42b. When each of the multilayer coil components 1, 1A, and 1B is solder-mounted on the electronic device, solder fillets may be formed on the main-surface electrode portions 41a and 42a and the end-surface electrode portions 41b, 42b. Therefore, the multilayer coil component 1, 1A, and 1B can improve mounting strength.

Each of the multilayer coil components 1, 1A, and 1B may include the connection conductors 51 and 52.

Each of the multilayer coil components 1, 1A, and 1B includes the connection conductors 51 and 52. In each of the multilayer coil components 1, 1A, and 1B, the connection conductor 51 is positioned to extend between the coil 3, 3A, 3B and the end-surface electrode portion 41b, and the connection conductor 52 is positioned to extend between the coil 3, 3A, 3B and the end-surface electrode portion 42b. Therefore, each of the multilayer coil components 1, 1A, and 1B can further prevent an increase in the stray capacitance, as compared with a configuration in which the connection conductor 51 is positioned to extend between the coil 3, 3A, 3B and the main-surface electrode portion 41a and the connection conductor 52 is positioned to extend between the coil 3, 3A, 3B and the main-surface electrode portion 42a.

The surface of the element body 2 may be exposed from the external electrode 41C, 42C, 41D, 42D except for the main surface 2a₁.

In the multilayer coil component 1C, the surface of the element body 2 is exposed from the external electrodes 41C and 42C except for the main surface 2a₁. The external electrodes 41C and 42C are disposed only on the principal surface 2a₁. In the multilayer coil component 1D, the surface of the element body 2 is exposed from the external electrodes 41D and 42D except for the main surface 2a₁. The external electrodes 41D and 42D are disposed only on the principal surface 2a₁. When each of the multilayer coil components 1C and 1D is solder-mounted, solder fillets tend not to form on the respective sides of the end surfaces 2c₁ and 2c₂. Therefore, each of the laminated coil components 1C and 1D reliably maintains mounting strength and can prevent an increase in a mounting area.

It is to be understood that not all aspects, advantages and features described herein may necessarily be achieved by, or included in, any one particular example. Indeed, having described and illustrated various examples herein, it should be apparent that other examples may be modified in arrangement and detail.

In each of the connecting portions 3a to 3e, 6a to 6e, 7a to 7h, and 8a to 8g, the adjacent coil conductors may not be directly continuous with each other. For example, the adjacent coil conductors may be indirectly continuous with each other via a through-hole conductor.

The region defining each of the depressions 21 and 22 formed in the element body 2 may include one or more regions. The region 2ab may include a region in which a corner portion and a ridge portions of the element body are chamfered and a region in which the corner portion and the ridge portion of the element body are rounded.

The multilayer coil component included in the present disclosure may include a configuration obtained by combining configurations included in each of the multilayer coil components 1, 1A, 1B, 1C, and 1D. For example, the multilayer coil component included in the present disclosure may include any one of the coils 3, 3A, 3B, and 3C, any one of the external electrodes 41, 41C, and 41D, and any one of the external electrodes 42, 42C and 42D.

What is claimed is:

1. A multilayer coil component comprising:
an element body including a main surface and a pair of side surfaces adjacent the main surface and opposing each other;
a coil in the element body including a plurality of coil conductors that are disposed in a direction in which the pair of side surfaces oppose each other and are electrically connected to each other; and
a pair of external electrodes each including a main-surface electrode portion on the main surface and electrically connected to the coil, wherein
the coil includes a plurality of connection portions each at which adjacent coil conductors of the plurality of coil conductors are electrically connected to each other and the adjacent coil conductors overlap each other in the direction in which the pair of side surfaces oppose each other,
the plurality of connection portions include a first connection portion and a second connection portion that is farther from the main-surface electrode portion than the first connection portion, and
a second area where the adjacent coil conductors overlap each other in the second connection portion is larger than a first area where the adjacent coil conductors overlap each other in the first connection portion.

2. The multilayer coil component according to claim 1, wherein
the element body includes another main surface opposing the main surface,
the main surface includes a first region and a second region closer to the other main surface than the first region, and
the main-surface electrode portion is disposed on the second region.

3. The multilayer coil component according to claim 1, wherein
the element body includes a pair of end surfaces adjacent to the main surface and the pair of side surfaces,
each of the pair of external electrodes includes an end-surface electrode portion on a corresponding end surface of the pair of end surfaces.

4. The multilayer coil component according to claim 3, further comprising a connection conductor between the end-surface electrode portion and the coil, the connection conductor electrically connecting the end-surface electrode portion and the coil.

5. The multilayer coil component according to claim 1, wherein
a surface of the element body is exposed from the pair of external electrodes except for the main surface.

6. The multilayer coil component according to claim 1, wherein
the adjacent coil conductors are continuous with each other at each of the plurality of the connection portions.

7. The multilayer coil component according to claim 1, wherein
the plurality of connection portions include a first group including a plurality of the first connection portions and a second group including a plurality of the second connection portions, and
a sum of the second areas in the second group is larger than a sum of the first areas in the first group.

8. The multilayer coil component according to claim 3, wherein
the plurality of connection portions include:
a third group including a plurality of the first connection portions adjacent to at least one of the main-surface electrode portion and the end-surface electrode portion; and
a fourth group including a plurality of the second connection portions excluding the first connection portion, and
a sum of the second areas in the fourth group is larger than a sum of the first areas in the third group.

9. A multilayer coil component comprising:
an element body including a main surface;
a coil in the element body including a plurality of coil conductors that are electrically connected to each other; and
a pair of external electrodes each including a main-surface electrode portion on the main surface and electrically connected to the coil, wherein
the coil includes a plurality of connection portions each at which adjacent coil conductors of the plurality of coil conductors are electrically connected to each other and the adjacent coil conductors overlap each other, and
the plurality of connection portions include:
a first connection portion that has a first area where the adjacent coil conductors overlap each other; and
a second connection portion that is farther from the main-surface electrode portion than the first connection portion, and has a second area larger than the first area and where the adjacent coil conductors overlap each other.

10. The multilayer coil component according to claim 9, wherein
the element body includes another main surface opposing the main surface,
the main surface includes a first region and a second region closer to the other main surface than the first region, and
the main-surface electrode portion is disposed on the second region.

11. The multilayer coil component according to claim 9, wherein
the element body includes a pair of end surfaces adjacent to the main surface,
each of the pair of external electrodes includes an end-surface electrode portion on a corresponding end surface of the pair of end surfaces.

12. The multilayer coil component according to claim 11, further comprising a connection conductor between the end-surface electrode portion and the coil, the connection conductor electrically connecting the end-surface electrode portion and the coil.

13. The multilayer coil component according to claim 9, wherein
a surface of the element body is exposed from the pair of external electrodes except for the main surface.

14. The multilayer coil component according to claim 9, wherein
the adjacent coil conductors are continuous with each other at each of the plurality of the connection portions.

15. The multilayer coil component according to claim 9, wherein
the plurality of connection portions include a first group including a plurality of the first connection portions and a second group including a plurality of the second connection portions, and
a sum of the second areas in the second group is larger than a sum of the first areas in the first group.

16. The multilayer coil component according to claim 11, wherein
the plurality of connection portions include:
a third group including a plurality of the first connection portions adjacent to at least one of the main-surface electrode portion and the end-surface electrode portion; and
a fourth group including a plurality of the second connection portions excluding the first connection portion, and
a sum of the second areas in the fourth group is larger than a sum of the first areas in the third group.
